(19) United States
(12) Patent Application Publication
(10) Pub. No.: US 2009/0072127 A1
(43) Pub. Date: Mar. 19, 2009

(54) ADJUSTABLE SHROUD FOR ADJUSTING A DETECTION FIELD ASSOCIATED WITH A DETECTOR

(75) Inventor: Wendell Dodson, St. Louis, MO (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: INTERGLOBAL, INC., St. Louis, MO (US)

(21) Appl. No.: 11/857,831

(22) Filed: Sep. 19, 2007

(51) Int. Cl. G02B 26/00; H01J 3/14

(52) U.S. Cl. 250/216; 359/232; 250/239; 359/894

(57) ABSTRACT

An adjustable shroud for use with a detector having an aperture for detecting electromagnetic radiation. The adjustable shroud includes a base element, a cover element and a directional shroud. The cover element and the directional shroud may be adjusted over an aperture of a detector to increase and/or decrease a detection field associated with the detector. The user is easily able to configure the adjustable shroud to block a portion of a detection field associated with the detector to eliminate unwanted environment factors.

### TECHNICAL FIELD OF THE INVENTION

Aspects of the present invention relates to an apparatus for adjusting the detection area associated with a sensor (e.g., a motion detection sensor, light sensor, etc.) for use in a light fixture and/or other electronic device. More specifically, aspects of the present invention relate to an adjustable shroud for adjusting a detection field associated with a detector.

### DESCRIPTION OF THE RELATED ART

Motion detection devices and light detection devices have been used in lighting control systems and security systems for a number of years. For example, motion detection devices are commonly used in automatic light switches and security systems to turn on a light or to activate some other form of alarm or warning indicator when a predetermined condition occurs. Such predetermined conditions include, for example, detecting a light and/or darkness, detecting a person or motor vehicle entering a monitored area, etc.

There are many drawbacks with such devices. For example, often times it is difficult to adjust and/or otherwise configure the detection field associated with the detectors to account for unwanted environmental factors (e.g., street lights, moving trees, etc.). Another drawback is the ability to allow the user to easily customize and/or configure the detection field for a wide range of environments and/or applications.

### SUMMARY

Aspects of the present invention relate to an apparatus for adjusting the detection area associated with a detector (e.g., a motion detection sensor, light detection sensor, etc.) for use in a light fixture and/or other electronic device.

One aspect of the present invention relates to an adjustable shroud for use with a detector having an aperture for detecting electromagnetic radiation, the adjustable shroud comprising: a base element; a directional shroud secured to the base element; a cover element coupled to the base element, wherein the cover element is configured to cooperate with the directional shroud to adjust a detection field associated with a detector.

Another aspect of the present invention relates to an adjustable shroud for use with a detector, the adjustable shroud including: a base element configured to be coupled to a detector having an aperture; and a cover element configured to be coupled to the base element, wherein the cover element is configured to modulate electromagnetic radiation from a portion of a detection field associated with the aperture by increasing and/or decreasing the detection field.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary block diagram of a system in accordance with aspects of the present invention.

FIGS. 2 and 3 are exemplary cross-sectional views of detection fields in accordance with aspects of the present invention.

FIG. 4 is an exemplary block diagram of a system in accordance with aspects of the present invention.

FIGS. 5-12 illustrate various exemplary views of configurations of the cover element that may be used to modulate electromagnetic radiation in accordance with aspects of the present invention.

FIG. 13 is an exemplary fixture in accordance with aspects of the present invention.

### DETAILED DESCRIPTION OF EMBODIMENTS

Aspects of the present invention relate to an adjustable shroud for use in conjunction light fixtures and other electronic devices that utilize a detector to detect a physical characteristic associated with the environment in which the device is placed or otherwise used. The adjustable shroud is generally positioned over an aperture that covers the sensing portion of the detector. The adjustable shroud may be adjusted to increase and/or decrease the associated detection field of the detector. The ability to easily adjust the position and size of the detection field makes the adjustable shroud suitable for a wide variety of applications.

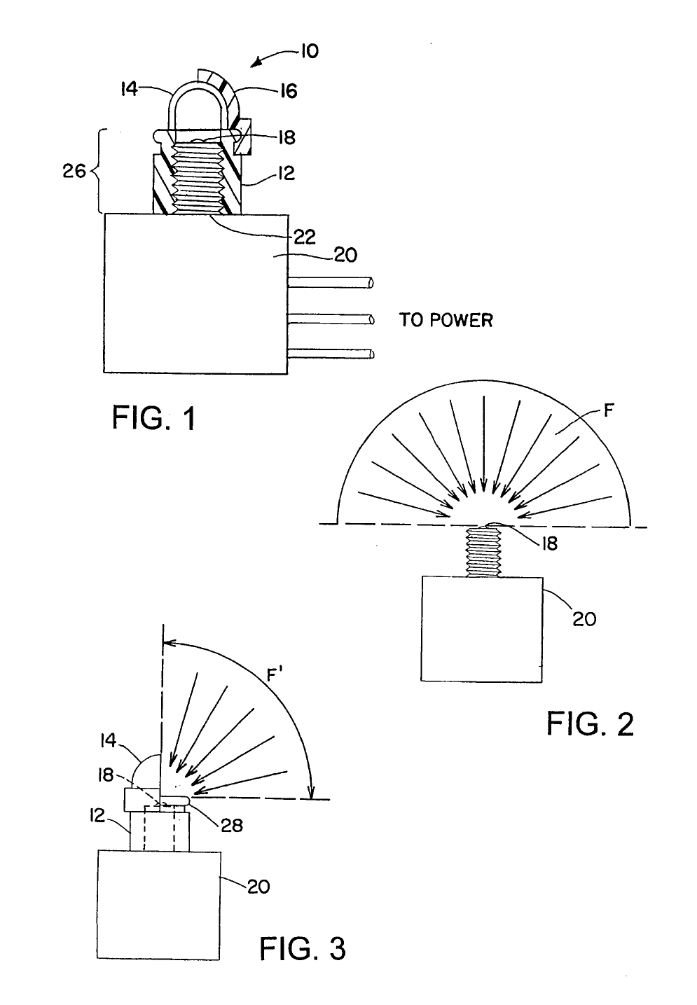

Referring to FIG. 1, an adjustable shroud 10 in accordance with aspects of the present invention is illustrated. The adjustable shroud 10 includes a base element 12, a directional shroud 14 and a cover element 16. As explained below, the base element 12 generally secures the directional shroud 14 and the cover element 16 in a desired position over the aperture 18 (FIG. 2) of a detector 20 (FIG. 2). The directional shroud 14 and the cover element 16 adjustably cooperate so that the user may adjust the amount of electromagnetic radiation that enters the aperture of the detector. The term “aperture” should be interpreted broadly to include an opening in which light is allowed to pass in optical systems such as cameras and lasers, and circuitry to detect radiation levels, such as optical sensors, radiation sensors, motion sensors, infrared sensors, etc. The term “detector” should be interpreted broadly to include any device for detecting the presence of any type of electromagnetic radiation.

The detector 20 may be any suitable detector. A suitable detector is generally a detector that is capable of sensing one or more physical characteristics of an environment or event in which the detector is located (e.g., motion, electromagnetic radiation, etc.). Referring to FIG. 2, an exemplary detection field “F” associated with an unobstructed two-dimensional aperture 18 of the detector 20 is illustrated. The detection field F is substantially hemispherical in three dimensions. Thus, the aperture 18 receives electromagnetic radiation from the entire detection field F. One of ordinary skill in the art will readily appreciate that any desired detection field may be obtained by configuring one or more suitable detectors and the scope of the present invention is in no way intended to be limited by the number, type and configuration of the detectors.

Referring to FIG. 3, detector 20 is illustrated having a base element 12 and directional shroud 14 disposed over the aperture 18 of the detector 20. As shown in FIG. 3, the directional shroud 14 limits the effective detection field of the aperture 18 from F (in FIG. 2) to F′. That is, the directional shroud 14 may be configured by a user to block unwanted areas within the detection field and/or sources from affecting operation of the sensor. The directional shroud 14 is generally rotatable with the base element 12 on the coupling mechanism 22. The directional shroud 14 may be configured in any desired size and shape. Once disposed over the aperture 18, the directional shroud 14 generally has a fixed detection field. While the size of the detection field is fixed, the user may position the directional shroud 14 to exclude certain unwanted areas. For example, if the user desired for a light fixture to turn on at dusk, a low hanging street light or other house light, for example, may interfere with operation of the light. The directional shroud 14 enables a user to remedy this problem by configuring the directional shroud 14 to block detection of electromagnetic radiation from the problem area to the aperture 18. The directional shroud 14 may be integrally formed with the base element 12 or be formed separately from the base element 12.

As shown in FIG. 1, the base element 12 generally includes coupling mechanism 22. The coupling mechanism 22 may be any desired mechanism that is configured position the adjustable shroud 10 over the aperture 18. For example, the coupling mechanism 22 may include a threaded region that cooperates with the detector housing 24 to secure the base element 12 over the detector 20. One of ordinary skill in the art will readily appreciate that a variety of other coupling mechanisms may be used, e.g., snap mountings, compression mountings, slide mountings, etc.

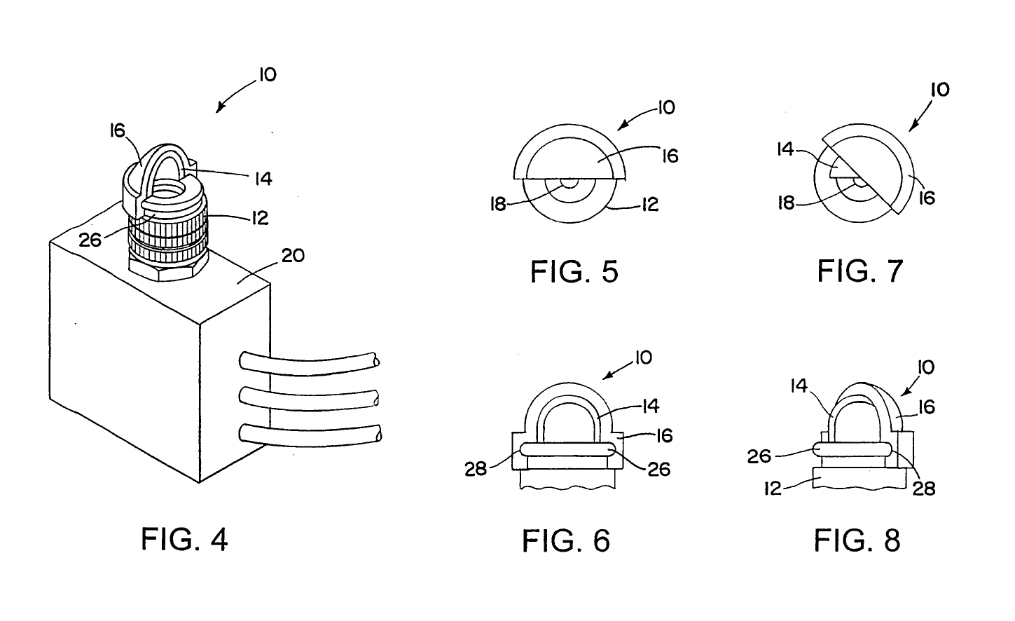

Referring to FIG. 1, the adjustable shroud 10 includes a cover element 16. Cover element 16 may be directly coupled to detector 20. In another embodiment, the cover element 16 may be coupled to the base element 12, which is coupled and/or otherwise secured to and/or disposed over the aperture 18 the detector 20, as shown in FIG. 4. For example, the cover element 16 may be coupled to the base element 12 with an interference fit and a guide 26 (e.g., a protrusion and/or channel) may be formed in the base element 12 that cooperates with a guide (e.g. protrusion and/or channel) 28 in the cover element 16 to facilitate movement between the base element 12 and the cover element 16. In another embodiment, the cover element 16 may be snap mounted to the periphery of the base element 12 and secured to the periphery of the base element 12 by an interference fit.

The cover element 16 may be of any desired size and shape. In one embodiment, the cover element 16 forms an arc that is approximately 180 degrees or more. Such a configuration allows the cover element 16 to take advantage of the geometry of the directional shroud 14 and allows the cover element 16 to be configured to open fully (when the cover element 16 is positioned behind the directional shroud 14, as shown in FIGS. 4-6. The cover element 16 may also be completely offset from the directional shroud 14 to completely prevent electromagnetic radiation from entering the aperture, as shown in FIG. 1. In most cases, the cover element 16 will be offset from the directional shroud 14 in order to allow some electromagnetic radiation to enter the aperture 18, as shown in FIGS. 7-12.

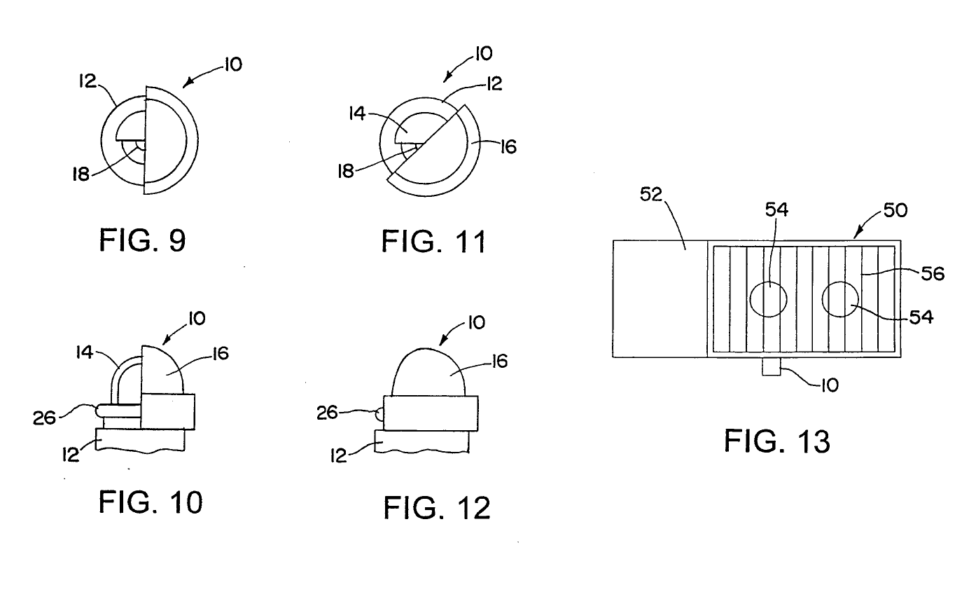

Referring to FIGS. 7 and 8, the cover element 16 and the directional shroud 14 are configured to allow approximately 120 degrees of the aperture 18 to be used to detect electromagnetic radiation entering the detector. Referring to FIGS. 9 and 10, the cover element 16 and the directional shroud 14 are configured to allow approximately 90 degrees of the aperture 18 to be used to detect electromagnetic radiation entering the detector. Referring to FIGS. 11 and 12, the cover element 16 and the directional shroud 14 are configured to allow approximately 45 degrees of the aperture 18 to be used to detect electromagnetic radiation entering the detector. Thus, the cover element 16 and the directional shroud 14 are configurable to allow a highly customizable detection field to used for modulation of electromagnetic radiation that enters the aperture 18 of the detector.

As shown above, the cover element 16 and the directional shroud 14 are configurable to provide any desirable detection field. Generally, the directional shroud 14, which may integrally formed with the base element 12 and/or fixedly secured thereto, is configured to block out one or more environmental factors that may disrupt desired operation of the detector 20. Once the directional shroud 14 is in place, the user may adjust the cover element 16 to fine tune any additional adjustments to block any other environmental factors in order to obtain desired operation. In another embodiment, both the directional shroud 14 and the cover element 16 may be configured by the user to obtain desired detector operation. In general, the directional shroud 14 and/or the cover element 16 may be configurable by a user simply by rotation of the particular element over the aperture 18 of the detector 20.

One of ordinary skill in the art will readily appreciate that the directional shroud 14 and the cover element 16 may be separate items and/or may be combined together in a single unit. That is, the adjustable shroud 10 may include a base element and an adjustable cover element that performs in a similar manner as described above with respect the operation of the directional shroud 14 and the cover element 16.

An exemplary embodiment of one aspect of the present invention is illustrated in FIG. 13. As shown in FIG. 13, a light fixture 50 that may be secured to a wall is illustrated. The light fixture 50 may include a housing 52, a light source 54 (e.g., a lens covering one or more light bulbs), a lens 56 and an adjustable shroud 10 contacted to a sensor (not shown). For example, the light fixture 50 may be a light that is operational when a predetermined level of darkness (or lack of light) is detected. The adjustable shroud 10 may be secured over the detector and configured, by the user positioning the directional shroud 14 and the cover element 16, to avoid unwanted environmental interference (e.g., light emanating from a nearby room) to interfere with operation of the detector.

The components of the adjustable shroud 10, including base element 12, directional shroud 14 and/or cover element 16 may be made of any desirable material. One suitable material is plastic. One of ordinary skill in the art will readily appreciate that a wide variety of materials may be suitable. Preferably, the cover element 16 and/or the directional shroud 14 are made of an opaque material. Optionally, a reflective paint and/or coating may be imparted on the inside (the part facing the aperture 18) for certain environment and/or applications (e.g., motion detection applications and/or low directional light setting environments, etc.).

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

What is claimed is:

1. An adjustable shroud for use with a detector having an aperture for detecting electromagnetic radiation, the adjustable shroud comprising:
a base element;
a directional shroud secured to the base element;
a cover element coupled to the base element, wherein the cover element is configured to cooperate with the directional shroud to adjust a detection field associated with a detector.

2. The adjustable shroud of claim 1, wherein the cover element is slidably adjustable over the directional shroud to adjust the detection field.

3. The adjustable shroud of claim 1, wherein the base element is removably secured by a threaded coupling mechanism that encapsulates at least a portion of the detector.

4. The adjustable shroud of claim 1, wherein the cover element is secured to the base element by a press-fit connection.

5. The adjustable shroud of claim 1, wherein the cover element is plastic.

6. The adjustable shroud of claim 5, wherein the cover element is opaque.

7. The adjustable shroud of claim 1, wherein the detector is at least one selected from the group of a photocell and a motion detection sensor.

8. The adjustable shroud of claim 1, wherein the directional shroud is fixedly secured to the base element.

9. An adjustable shroud for use with a detector, the adjustable shroud comprising:
a base element configured to be coupled to a detector having an aperture; and
a cover element configured to be coupled to the base clement, wherein the cover element is configured to modulate electromagnetic radiation from a portion of a detection field associated with the aperture by increasing and/or decreasing the detection field.

10. The adjustable shroud of claim 9, wherein the cover element is coupled to the base element by an interference fit.

11. The adjustable shroud of claim 9, wherein the cover element is slidably coupled to the base element.

12. The adjustable shroud of claim 9, wherein the base element includes a guide slot on an exterior surface.

13. The adjustable shroud of claim 12, wherein the cover element includes a guide protrusion configured to cooperate with the guide slot.

14. The adjustable shroud of claim 9, wherein the cover element is plastic.

15. The adjustable shroud of claim 14, wherein the adjustable cover element is opaque.

16. The adjustable shroud of claim 9, wherein the base element includes a directional shroud

17. The adjustable shroud of claim 16, wherein the cover element is rotatably adjustable around at least a portion of the base element and cooperates with the directional shroud to modulate the detection field.

18. The adjustable shroud of claim 16, wherein the directional shroud is fixedly mounted to the base element.

19. The adjustable shroud of claim 16, wherein the directional shroud is integrally formed with the base element.
